(19) United States
(12) Patent Application Publication
(10) Pub. No.: US 2014/0125552 A1
(43) Pub. Date: May 8, 2014

(54) ANTENNA AND ANTENNA UNIT INCLUDING SAME

(71) Applicants: Ryo TAKISAWA, Tokyo (JP); Akira MIYOSHI, Tokyo (JP)

(72) Inventors: Ryo TAKISAWA, Tokyo (JP); Akira MIYOSHI, Tokyo (JP)

(73) Assignee: Mitsumi Electric Co., Ltd., Tokyo (JP)

(21) Appl. No.: 14/060,738

(22) Filed: Oct. 23, 2013

(30) Foreign Application Priority Data
Nov. 2, 2012 (JP) 2012-242363

(51) Int. Cl. H01Q 1/36

(52) U.S. Cl. CPC H01Q 1/362
USPC 343/895

(57) ABSTRACT

An antenna includes a support body having a rod shape, a first helical antenna element, and a second helical antenna element. The first helical antenna element is wound about the axis of the support body. The second helical antenna element overlaps the first helical antenna element with an insulator provided between the first helical antenna element and the second helical antenna element. The second helical antenna element is wound about the axis in a direction opposite to a direction in which the first helical antenna element is wound.

### CROSS-REFERENCE TO RELATED APPLICATION

This application is based upon and claims the benefit of priority of Japanese Patent Application No. 2012-242363, filed on Nov. 2, 2012, the entire contents of which are incorporated herein by reference.

### BACKGROUND OF THE INVENTION

1. Field of the Invention

The present invention relates to an antenna including two or more helical antenna elements, and an antenna unit including the antenna.

2. Description of the Related Art

Antennas including two or more helical antenna elements are described in, for example, Japanese Laid-Open Patent Applications No. 2003-37426 (Patent Document 1) and No. 2011-151573 (Patent Document 2).

### SUMMARY OF THE INVENTION

According to an aspect of the present invention, an antenna includes a support body having a rod shape, a first helical antenna element wound about an axis of the support body, and a second helical antenna element that overlaps the first helical antenna element with an insulator provided between the first helical antenna element and the second helical antenna element, and that is wound about the axis in a direction opposite to a direction in which the first helical antenna element is wound.

According to an aspect of the present invention, an antenna unit includes the antenna as set forth above and a base part that houses an electronic circuit part electrically connected to the first helical antenna element and the second helical antenna element.

The object and advantages of the invention will be realized and attained by means of the elements and combinations particularly pointed out in the claims.

It is to be understood that both the foregoing general description and the following detailed description are exemplary and explanatory and not restrictive of the invention.

### BRIEF DESCRIPTION OF THE DRAWINGS

Other objects, features and advantages of the present invention will become more apparent from the following detailed description when read in conjunction with the accompanying drawings, in which:

FIG. 1 is a diagram illustrating a configuration of an antenna unit according to an embodiment;

FIG. 2 is a side view of a sub assembly formed into an antenna according to an embodiment;

FIG. 3 is a side view of an antenna according to an embodiment;

FIG. 4 is a side view of a root part of an antenna and a connector part attached to the root part;

FIG. 5 illustrates a return loss characteristic in the case where two antenna elements are wound in opposite directions;

FIG. 6 illustrates a return loss characteristic in the case where two antenna elements are wound in the same direction; and

FIG. 7 illustrates an antenna gain characteristic in the case where two antenna elements are wound in opposite directions and an antenna gain characteristic in the case where two antenna elements are wound in the same direction.

### DETAILED DESCRIPTION OF THE PREFERRED EMBODIMENTS

According to the techniques described in Patent Documents 1 and 2 mentioned above, the winding pitch of a first helical antenna element needs to be increased to allow a second helical antenna element to be provided in the space of the windings of the first helical antenna element. Therefore, the length of the first helical antenna element increases, thus making it difficult to reduce the size of the antenna.

According to an aspect of the present invention, it is possible to easily reduce the size of an antenna even when the antenna includes two or more helical antenna elements.

According to an aspect of the present invention, an antenna that is easily reducible in size even with two or more helical antenna elements and an antenna unit that includes the antenna are provided.

A description is given below, with reference to the accompanying drawings, of embodiments of the present invention.

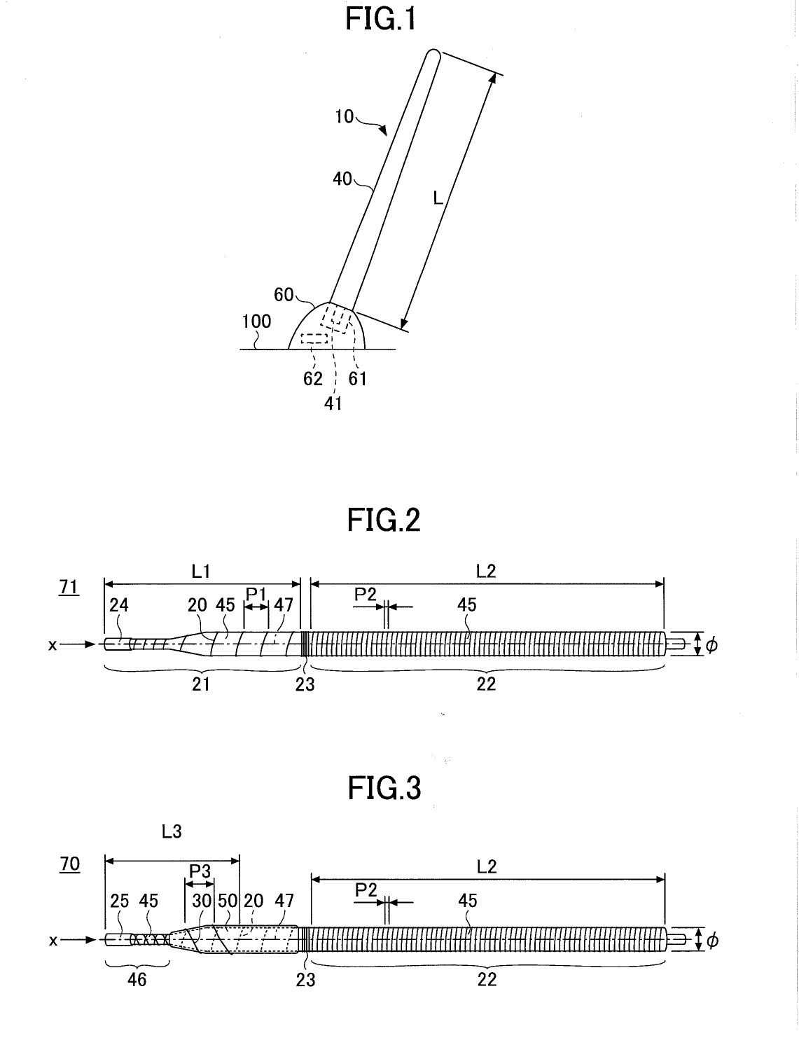

FIG. 1 is a side view of an antenna unit 10, which is an embodiment of the present invention, illustrating a state where the antenna unit 10 is fixed to a vehicle body 100. The antenna unit 10, which is for vehicles such as automobiles, includes a base part 60 and a rod part 40 connected to the base part 60. The base part 60 is fixed to the vehicle body 100 (for example, a surface of a rear part of the roof of a vehicle) with a predetermined fixing member.

The base part 60 includes a connector part 61 and an electronic circuit part 62. The connector part 61 is connected to a connector part 41 provided in a lower end portion of the rod part 40. The electronic circuit part 62 is electrically connected to the connector part 61. The connector part 41 and the connector part 61 are mechanically and electrically connected, so that helical antenna elements formed into a below-described rod antenna 70 (FIG. 3) housed in the rod part 40 are electrically connected to the electronic circuit part 62 included in the base part 60. The electrical connection of the helical antenna elements of the rod antenna 70 and the electronic circuit part 62 makes it possible to transmit signals between the helical antenna elements and the electronic circuit part 62. The electronic circuit part 62 includes, for example, a circuit board on which an amplifier that amplifies a signal received with the helical antenna elements of the rod antenna 70 is mounted.

FIG. 2 and FIG. 3 are diagrams for illustrating a configuration of the rod antenna 70. FIG. 2 is a side view of a sub assembly 71 before completion of the rod antenna 70 of FIG. 3. FIG. 3 is a side view of the completed rod antenna 70. The rod antenna 70 is a normal-mode helical antenna, of which one turn (one winding) is sufficiently short relative to wavelength. The rod antenna may also be referred to as “pole antenna.”

The rod antenna 70 includes a rod-shaped support body. FIG. 2 and FIG. 3 illustrate a core rod 45 as an example of the rod-shaped support body. The core rod 45 is a pillar-shaped member of an insulating material such as resin. The core rod 45 is preferably flexible for installation on vehicles. The core rod 45 may have a shape other than a pillar shape, such as a tubular shape or a shape of a conic solid as long as the shape is a rod shape. In FIG. 2 and FIG. 3, the columnar core rod 45, which includes a tapered portion on the side of a root part 46 of the core rod 45, is illustrated as an example.

The rod antenna 70 includes a first helical antenna element and a second helical antenna element. The first helical antenna element is wound about the axis of a rod-shaped support body. The second helical antenna element overlaps the first helical antenna element with an insulator provided between the first helical antenna element and the second helical antenna element, and is wound about the axis in a direction opposite to a direction in which the first helical antenna element is wound. In FIG. 2 and FIG. 3, an antenna winding 20 helically wound around the outer peripheral surface of the core rod 45 about an axis line 47 of the core rod 45 is illustrated as an example of the first helical antenna element. In FIG. 3, an antenna winding 30 helically wound about the axis line 47 in a direction opposite to a direction in which the antenna winding 20 is wound, overlapping the antenna winding 20 so as to cross the antenna winding 20 with an insulating material 50 provided between the antenna winding 20 and the antenna winding 30, is illustrated as an example of the second helical antenna element. In the case of FIG. 3, the antenna winding 30 is wound around outside the antenna winding 20. Therefore, part of the antenna winding 20 positioned between the outer peripheral surface of the core rod 45 and the insulating material 50 is indicated by a dotted line.

Thus, the rod antenna 70 includes the antenna winding 20 and the antenna winding 30, which are placed one over the other with the insulating material 50 provided between the antenna winding 20 and the antenna winding 30. This makes it possible to easily reduce the size of the rod antenna 70 and the rod part 40 covering the rod antenna 70, while ensuring an increase in bandwidth due to the antenna winding 20 and the antenna winding 30. For example, it is possible to easily reduce the overall length of the rod antenna 70, and accordingly, it is possible to easily reduce the overall length L of the rod part 40 (FIG. 1) as well.

Furthermore, because the antenna winding 30 is wound around outside the antenna winding 20, it is possible to wind the antenna winding 30 without changing the manner of winding the antenna winding 20. Accordingly, it is possible to later attach the antenna winding 30 designed to have desired characteristics without a substantial effect on the antenna characteristics of the antenna winding 20.

When viewed in an extension direction x of the axis line 47 of the core rod 45, the antenna winding 20 is wound counterclockwise around the outer peripheral surface of the core rod 45, and the antenna winding 30 is wound clockwise around and outside the antenna winding 20. The manner of winding the antenna winding 20 and the antenna winding 30 is not limited to this. For example, when viewed in the extension direction x, the antenna winding 20 may be wound clockwise around the outer peripheral surface of the core rod 45 and the antenna winding 30 may be wound counterclockwise around and outside the antenna winding 20.

The antenna winding 20 and the antenna winding 30 are thus wound in opposite directions about the axis line 47 extending in a longitudinal direction of the core rod 45, so that the electric field component of the antenna winding 20 and the electric field component of the antenna winding 30 are less likely to be coupled compared with the case of winding the antenna winding 20 and the antenna winding 30 in the same direction. Accordingly, the antenna winding 20 and the antenna winding 30 are less likely to affect each other in terms of electric fields. As a result, it is possible to increase the antenna gain of the antenna winding 20 and the antenna winding 30. Furthermore, it is possible to broaden the operating frequency band of the antenna winding 20 and the antenna winding 30.

Furthermore, in the case of FIG. 2, a lower end portion of the antenna winding 20 may be fixed to the core rod 45 with a tape 24 in order to facilitate the winding of the antenna winding 20 around the core rod 45. Likewise, a lower end portion of the antenna winding 30 may be so fixed with a tape 25 as to be placed over the tape 24, in order to facilitate the winding of the antenna winding 30 over the antenna winding 20 and the insulating material 50. Fixing members such as the tape 24 and the tape 25 may be any members other than tape (for example, caps, rings, etc.), and may be conductors or insulators.

In the case of using the rod antenna 70 as a multi-frequency antenna capable of transmitting and receiving radio waves of different frequency bands, the antenna winding 20 and the antenna winding 30 may be adjusted to lengths different from each other. For example, the antenna winding 20 may be adjusted to a length so as to operate in a predetermined first frequency band, and the antenna winding 30 may be adjusted to a length so as to operate in a second frequency band different from the first frequency band. In the case of FIG. 2 and FIG. 3, the length (L1+L2) of the antenna winding 20 is greater than the length L3 of the antenna winding 30. That is, the antenna winding 30 is capable of transmitting and receiving radio waves higher in frequency band than radio waves that the antenna winding 20 is capable of transmitting and receiving. For example, in the case of exciting the antenna winding 30 in the GSM (Global System for Mobile Communication, registered trademark)-800 frequency band (824 MHz to 960 MHz), it is preferable that L3 be set to 60 mm to 80 mm.

Furthermore, the antenna winding 20 includes a winding part 21 as a first winding part longer than the antenna winding 30, and a winding part 22 as a second winding part having a narrower winding pitch than the winding part 21. That is, the length L1 of the winding part 21 is greater than the length L3 of the antenna winding 30, and a winding pitch P2 between adjacent windings of the winding part 22 is narrower than a winding pitch P1 between adjacent windings of the winding part 21. This makes it possible for the antenna winding 20 to transmit and receive, in the winding part 21, radio waves lower in frequency band than radio waves that the antenna winding 30 is capable of transmitting and receiving and to transmit and receive, in the winding part 21 and the winding part 22, radio waves lower in frequency band than radio waves transmittable and receivable in the winding part 21. Furthermore, the length L2 of the winding part 22 may be reduced by making the winding pitch P2 narrower than the winding pitch P1. This makes it possible to reduce the length (L1+L2) of the antenna winding 20 while ensuring the capability to transmit and receive, in the winding part 21 and the winding part 22, radio waves lower in frequency band than radio waves transmittable and receivable in the winding part 21. The winding pitch P3 of the antenna winding 30 may be equal to or different from the winding pitch P1 of the winding part 21.

The winding part 21 is provided in a lower end portion of the core rod 45 and the winding part 22 is provided in an upper end portion of the core rod 45. The winding part 21 and the winding part 22 are formed of a continuous winding wire into a coil shape.

The antenna winding 20 includes a filter part 23 provided between the winding part 21 and the winding part 22. The filter part 23 is formed by closely winding the same continuous winding wire of the winding part 21 and the winding part 22 around the core rod 45 at a pitch that is narrower than the winding pitches P1 and P2 and is greater than zero. The closely wound winding wire increases the inductance component of a connecting part between the winding part 21 and the winding part 22, so that the connecting part operates as a filter. The filter part 23 may alternatively be any filter component instead of being formed of the same continuous winding wire of the winding part 21 and the winding part 22.

The insulating material 50 is an insulating layer interposed between the antenna winding 20 and the antenna winding 30. The insulating material 50 may be a sheet member rolled up into a tubular shape or a resin molding formed into a tubular shape. Furthermore, in the case of FIG. 2 and FIG. 3, for insulation between the winding part 21 and the antenna winding 30, the insulating material 50 is wound around the winding part 21 from its outer peripheral side so as to cover the winding part 21.

When the insulating material 50 is an adhesive material such as adhesive tape having adhesiveness, it is possible to stably fix the antenna winding 20 onto the outer peripheral surface of the core rod 45 while ensuring insulation between the antenna winding 20 and the antenna winding 30. When the outer peripheral surface of the insulating material 50 is adhesive, it is possible to stably fix the antenna winding 30 to the insulating material 50.

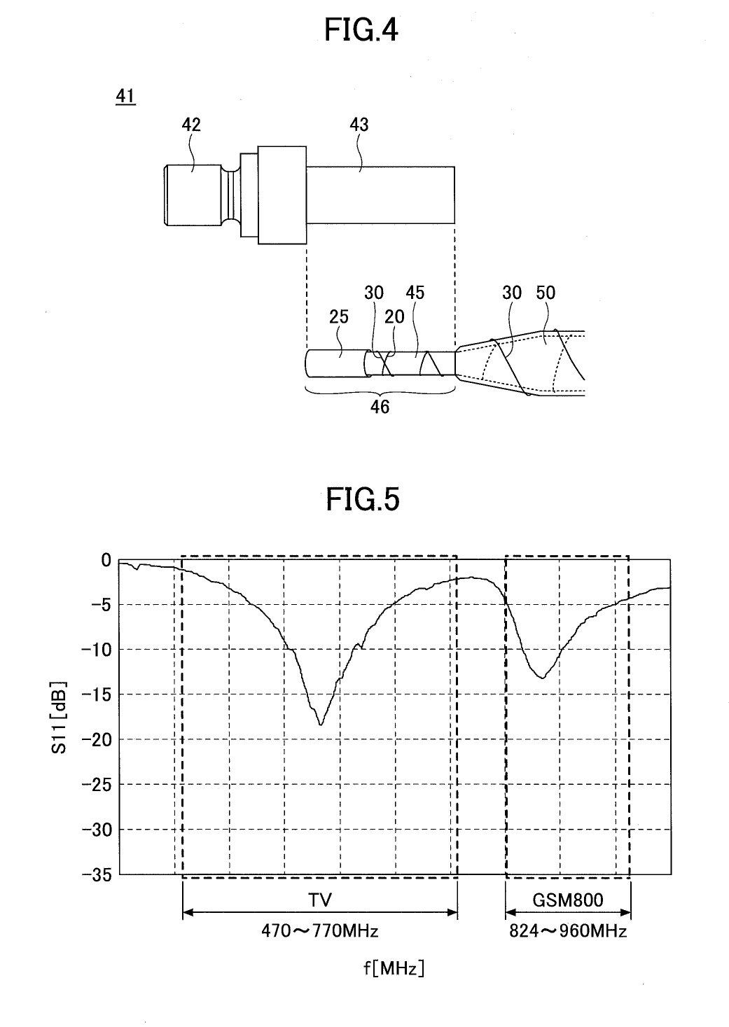

FIG. 4 is a side view of the connector part 41 illustrated in FIG. 1 and the root part 46 of the rod antenna 70, which is connected to the connector part 41. The insulating material 50 is wound around outside the antenna winding 20 except for the root part 46.

The connector part 41 includes an attachment part 42, which is connected to the connector part 61 of the base part 60 illustrated in FIG. 1, and a tubular part 43, to which the root part 46 is connected. The connector part 41 is an electrically conductive metal part into which the attachment part 42 and the tubular part 43 are unitarily formed.

The attachment part 42 includes, for example, an external thread portion that may be fastened to an internal thread portion of the connector part 61. The tubular part 43 includes an inner circumferential portion that accommodates the root part 46. The root part 46 is inserted into and comes into contact with the tubular part 43, so that each of the antenna winding 20 and the antenna winding 30 is electrically connected to the tubular part 43 at the root part 46. The tubular part 43 is electrically connected to the antenna winding 20 and the antenna winding 30 at the root part 46 by, for example, caulking or soldering.

The antenna winding 20 and the antenna winding 30 are electrically connected to the tubular part 43, so that the antenna winding 20 and the antenna winding 30 are electrically connected to the electronic circuit part 62 via the attachment part 42 and the connector part 61 of the base part 60. That is, the connector part 61, the connector part 41, and the root part 46 correspond to a feed part common to the antenna winding 20 and the antenna winding 30.

### [Experimental Results]

Next, a description is given of the results of measuring the antenna characteristics of rod antennas by changing only the winding direction without changing the dimensions of the antenna winding 20 and the antenna winding 30 in the embodiment of the rod antenna 70 illustrated in FIG. 3. In this experiment, the length L1 of the winding part 21 of the antenna winding 20 was set to such a length as to excite the winding part 21 in the digital terrestrial television broadcasting band (470 MHz to 770 MHz). Furthermore, the length (L1+L2) of the antenna winding 20 was set to such a length as to excite the antenna winding 20 in the FM broadcasting band (76 MHz to 108 MHz [the Japanese FM broadcasting band of 76 MHz to 90 MHz and the United States FM broadcasting band of 88 MHz to 108 MHz]) and the AM radio broadcasting band (520 kHz to 1700 kHz). Furthermore, the length L3 of the antenna winding 30 was set to such a length as to excite the antenna winding 30 in the GSM-800 frequency band (824 MHz to 960 MHz).

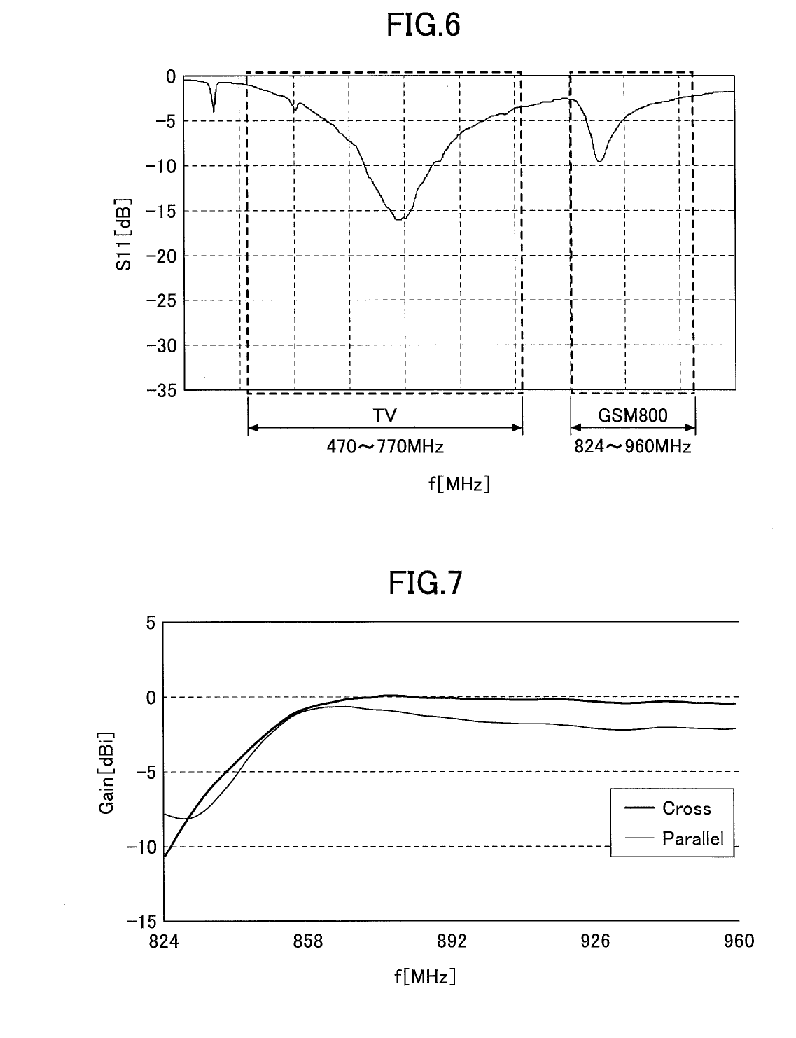

FIG. 5 illustrates the S11 characteristic of a rod antenna in which the antenna winding 20 and the antenna winding 30 are wound in directions opposite to each other (that is, an embodiment of the present invention). FIG. 6 illustrates the S11 characteristic of a rod antenna in which the antenna winding 20 and the antenna winding 30 are wound in the same winding direction (that is, a comparative example in which the techniques of Patent Documents 1 and 2 are applied). In FIG. 4 and FIG. 5, S11 of the vertical axis represents return loss with respect to each frequency f.

As is clear from FIG. 5 and FIG. 6, a favorable outcome was obtained that the peaks of return loss in the terrestrial television broadcasting and GSM-800 of FIG. 5 are lower by approximately 2 dB to 3 dB than in the case of FIG. 6. Furthermore, it was possible to broaden each of the frequency bands remote from each other in the case of FIG. 5, when comparing FIG. 5 and FIG. 6, setting −10 dB as a reference value, for example.

FIG. 7 illustrates the result of comparison of antenna gains due to the different winding directions of the antenna windings 20 and 30. In FIG. 7, “Cross” indicates the antenna gain of the rod antenna in which the antenna windings 20 and 30 are wound in opposite directions, and “Parallel” indicates the antenna gain of the rod antenna in which the antenna windings 20 and 30 are wound in the same direction. As illustrated in FIG. 7, it was possible to increase the antenna gain over substantially the entire frequency f range of GSM-800 by winding the two antenna windings 20 and 30 in directions opposite to each other.

A description is given above of an antenna and an antenna unit including the antenna based on embodiments. All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

For example, the number of helical antenna elements is not limited to two, and may be three or more. Furthermore, the winding wires of the first helical antenna element and the second helical antenna element may have the same diameter or different diameters. Furthermore, the first helical antenna element and the second helical antenna element may have the same winding pitch or different winding pitches. Furthermore, the respective winding pitches of the first helical antenna element and the second helical antenna element may change or be constant along the length of the first helical antenna element and the second helical antenna element. Furthermore, the respective winding diameters of the first helical antenna element and the second helical antenna element may change or be constant along the length of the first helical antenna element and the second helical antenna element. Furthermore, the dimensions of the illustrated helical antenna elements, such as the number of windings n, the length L, the pitch P, and the winding diameter φ, are no more than examples, and may be changed as desired in accordance with desired antenna characteristics.

Furthermore, in the above-described embodiments, the core rod 45 is illustrated as an example of the rod-shaped support body. The rod-shaped support body, however, may be the rod part 40 (FIG. 1), which covers and accommodates the rod antenna 70.

Furthermore, the insulator interposed between the antenna winding 20 and the antenna winding 30 may be an insulating coat formed on a surface of at least one of the antenna winding 20 and the antenna winding 30.

Furthermore, according to the above-described embodiments, both of the first helical antenna element and the second helical antenna element are wound around outside the core rod 45, which is a rod-shaped support body. When the core rod 45 has a tubular shape, however, one or both of the first helical antenna element and the second helical antenna element may be wound around inside the core rod 45. Furthermore, according to the above-described embodiments, a helical antenna element shorter in overall length is wound around outside a helical antenna element longer in overall length (the antenna element 30 is wound around outside the antenna element 20), the helical antenna element shorter in overall length may be wound around inside the helical antenna element longer in overall length.

Furthermore, when the first helical antenna element is longer than the second helical antenna element, it is preferable that the first helical antenna element be used for the VHF band of 30 MHz to 0.3 GHz. The radio waves of the VHF band are used for, for example, the Japanese FM broadcasting band (76 MHz to 90 MHz), the United states FM broadcasting band (88 MHz to 108 MHz), the television broadcasting bands (90 MHz to 108 MHz and 170 MHz to 222 MHz), the band III (174 MHz to 240 MHz) of Digital Audio Broadcasting (DAB). Furthermore, it is preferable that the first helical antenna element be used for, for example, the MF band of 300 kHz to 3 MHz. The radio waves of the MF band are used for, for example, AM radio broadcasting (520kHz to 1700kHz).

Furthermore, when the first helical antenna element is longer than the second helical antenna element, it is preferable that the second helical antenna element be used for the UHF band of 0.3 GHz to 3 GHz. The radio waves of the UHF band are used for, for example, a keyless entry system for vehicles (300 MHz to 450 MHz), the 800 MHz band for car phones (824 MHz to 960 MHz), the L band of DAB (1452 MHz to 1492 MHz), the 1.5 GHz band for car phones (1.429 GHz to 1.501 GHz), the Global Positioning System (GPS) signals of satellites (1575.42 MHz), and Vehicle Information and Communication System (VICS, registered trademark) (2.5 GHz).

What is claimed is:

1. An antenna, comprising:
a support body having a rod shape;
a first helical antenna element wound about an axis of the support body; and
a second helical antenna element that overlaps the first helical antenna element with an insulator provided between the first helical antenna element and the second helical antenna element, and that is wound about the axis in a direction opposite to a direction in which the first helical antenna element is wound.

2. The antenna as claimed in claim 1, wherein a length of the first helical antenna element is greater than a length of the second helical antenna element.

3. The antenna as claimed in claim 2, wherein the first helical antenna element includes
a first winding part having a length greater than the length of the second helical antenna element; and
a second winding part having a winding pitch smaller than a winding pitch of the first winding part.

4. The antenna as claimed in claim 1, wherein the second helical antenna element is wound around outside the first helical antenna element.

5. The antenna as claimed in claim 1, wherein the first helical antenna element and the second helical antenna element are electrically connected at a root part of the support body.

6. An antenna unit, comprising:
the antenna as set forth in claim 1; and
a base part that houses an electronic circuit part electrically connected to the first helical antenna element and the second helical antenna element.
